(19) United States
(12) Patent Application Publication
(10) Pub. No.: US 2024/0303962 A1
(43) Pub. Date: Sep. 12, 2024

(54) METHOD OF DETERMINING IMAGE FEATURE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Bi LI, Beijing (CN); Nan PENG, beijing (CN); Teng XI, Beijing (CN); Gang ZHANG, Beijing (CN)

(73) Assignee: BEIJING BAIDU NETCOM SCIENCE TECHNOLOGY CO., LTD., Beijing (CN)

(21) Appl. No.: 18/020,914

(22) PCT Filed: Apr. 22, 2022
(86) PCT No.: PCT/CN2022/088396

§ 371 Date: Feb. 10, 2023

(30) Foreign Application Priority Data
Aug. 13, 2021 (CN) 202110934300.7

(51) Int. Cl. G06V 10/50; G06V 10/26; G06V 10/42; G06V 10/44

(52) U.S. Cl. CPC G06V 10/50; G06V 10/26; G06V 10/42; G06V 10/44

(57) ABSTRACT

A method of determining an image feature, an electronic device, and a storage medium are provided, which relate to the field of artificial intelligence technology, in particular to fields of computer vision and depth learning technology, and may be applied to scenarios such as image processing and image recognition. The method includes: dividing an original image into a plurality of local images as an image to be processed, and each local image includes a plurality of image blocks; determining a local feature of the image to be processed according to a relationship between each image block in each local image; and determining a global feature of the image to be processed according to a relationship between a first image block at a preset position in a local image and one or more second image blocks at the preset position in other local images of the plurality of local images.

This application claims priority to Chinese Patent Application No. 202110934300.7, filed on Aug. 13, 2021, the entire content of which is incorporated herein in its entirety by reference.

### TECHNICAL FIELD

The present disclosure relates to the field of artificial intelligence technology, in particular to fields of computer vision and deep learning technology, which may be applied to scenarios such as image processing and image recognition. More specifically, the present disclosure provides a method and an apparatus of determining an image feature, an electronic device, and a storage medium.

### BACKGROUND

An image feature includes a global feature and a local feature. The global feature may be calculated by using a Transformer model. A receptive field of a first layer of the Transformer model covers all inputs, so the Transformer model has an ability to calculate the global feature. The local feature may be calculated by using a convolutional neural network (CNN) model. A receptive field of a first layer of the CNN model may cover a local input, so the CNN model has an ability to calculate the local feature.

### SUMMARY

The present disclosure provides a method and an apparatus of determining an image feature, a device, and a storage medium.

According to a first aspect, a method of determining an image feature is provided, including: dividing an original image into a plurality of local images as an image to be processed, wherein each local image of the plurality of local images includes a plurality of image blocks; determining a local feature of the image to be processed according to a relationship between each image block in each local image; and determining a global feature of the image to be processed according to a relationship between a first image block at a preset position in a local image of the plurality of local images and one or more second image blocks at the preset position in other local images of the plurality of local images.

According to a second aspect, an apparatus of determining an image feature is provided, including: a dividing module configured to divide an original image into a plurality of local images as an image to be processed, wherein each local image of the plurality of local images includes a plurality of image blocks; a first determination module configured to determine a local feature of the image to be processed according to a relationship between each image block in each local image; and a second determination module configured to determine a global feature of the image to be processed according to a relationship between a first image block at a preset position in a local image of the plurality of local images and one or more second image blocks at the preset position in other local images of the plurality of local images.

According to a third aspect, an electronic device is provided, including: at least one processor; and a memory communicatively connected to the at least one processor, wherein the memory stores instructions executable by the at least one processor, and the instructions, when executed by the at least one processor, cause the at least one processor to implement the method provided by the present disclosure.

According to a fourth aspect, a non-transitory computer-readable storage medium having computer instructions stored thereon is provided, wherein the computer instructions are configured to cause a computer to implement the method provided by the present disclosure.

According to a fifth aspect, a computer program product containing a computer program/instruction is provided, wherein the computer program/instruction, when executed by a processor, causes the processor to implement the method provided by the present disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, in which:

FIG. 1 is a schematic diagram of an exemplary system architecture to which a method and an apparatus of determining an image feature may be applied according to an embodiment of the present disclosure;

FIG. 2 is a flowchart of a method of determining an image feature according to an embodiment of the present disclosure;

FIG. 3 is a flowchart of a method of determining an image feature according to another embodiment of the present disclosure;

FIG. 4 is a flowchart of a method of determining an image feature according to another embodiment of the present disclosure;

FIG. 5A is a schematic diagram of calculating a local feature according to an embodiment of the present disclosure;

FIG. 5B is a schematic diagram of calculating a global feature according to an embodiment of the present disclosure;

FIG. 6 is a block diagram of an apparatus of determining an image feature according to an embodiment of the present disclosure; and

FIG. 7 is a block diagram of an electronic device to which a method and an apparatus of determining an image feature may be applied according to an embodiment of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

An image feature includes a global feature and a local feature. The local feature may be calculated by using a convolutional neural network (CNN) model. The global feature may also be calculated by using the CNN model. A receptive field of each layer of the CNN model may cover a local input. The number of layers of the CNN may be increased, and then the receptive field may be expanded, so that the CNN may also have an ability to calculate the global feature. The global feature may also be calculated by using a Transformer model, and the Transformer model also includes a plurality of neural network layers. The receptive field may cover all inputs from a first layer of the Transformer model, so that the Transformer model has the ability to calculate the global feature.

Computing the local feature requires a less amount of computation, but an expression ability of the local feature is poor. The global feature has a strong expression ability, but computing the global feature requires a huge amount of computation, which is not conducive to deployment under a condition of computing constraints.

It should be noted that, in the technical solution of the present disclosure, the collection, storage, use, processing, transmission, provision, disclosure and application of the user's personal information involved are all in compliance with the relevant laws and regulations, and necessary confidentiality measures have been taken, and do not violate the public order and good customs.

In the technical solution of the present disclosure, the authorization or consent of the user is acquired before the user's personal information is acquired or collected.

FIG. 1 is an exemplary system architecture to which a method and an apparatus of determining an image feature may be applied according to an embodiment of the present disclosure. It should be noted that FIG. 1 is only an example of a system architecture to which the embodiments of the present disclosure may be applied, so as to help those skilled in the art to understand the technical content of the present disclosure, but it does not mean that the embodiments of the present disclosure cannot be used for other devices, systems, environment or scenes.

As shown in FIG. 1, a system architecture 100 according to this embodiment may include a plurality of terminal devices 101, a network 102, and a server 103. The network 102 is a medium used to provide a communication link between the terminal device 101 and the server 103. The network 102 may include various connection types, such as wired and/or wireless communication links, and the like.

A user may use the terminal device 101 to interact with the server 103 through the network 102 to receive or send a massage and the like. The terminal device 101 may be various electronic devices, including but not limited to a smart phone, a tablet, a laptop, and the like.

The method of determining an image feature provided by the embodiments of the present disclosure may generally be executed by the server 103. Correspondingly, the apparatus of determining an image feature provided by the embodiments of the present disclosure may be disposed in the server 103. The method of determining an image feature provided by the embodiments of the present disclosure may also be executed by a server or a server cluster different from the server 103 and capable of communicating with the terminal 101 and/or the server 103. Correspondingly, the apparatus of determining an image feature provided by the embodiments of the present disclosure may also be provided in the server or the server cluster different from the server 103 and capable of communicating with the terminal device 101 and/or the server 103.

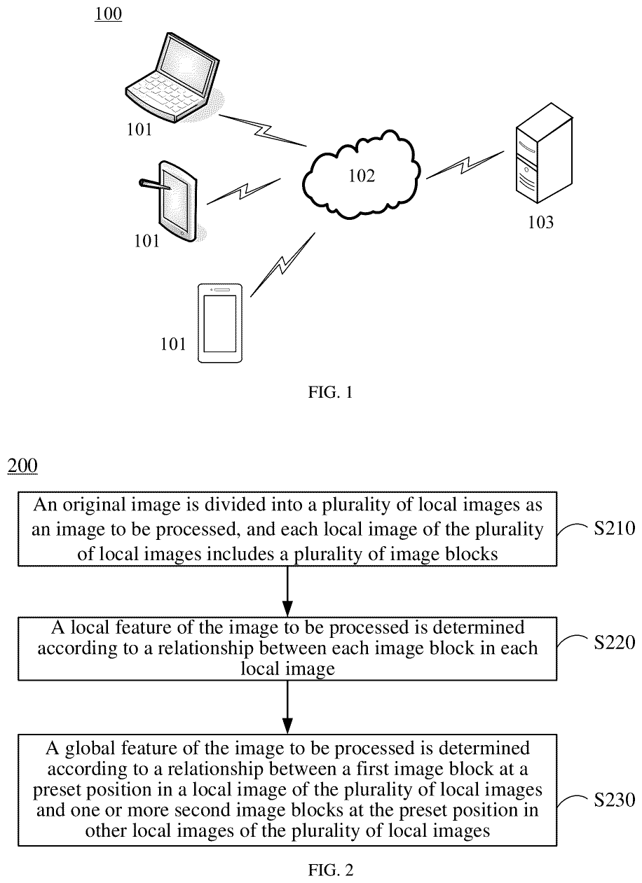

FIG. 2 is a flowchart of a method of determining an image feature according to an embodiment of the present disclosure.

As shown in FIG. 2, a method 200 of determining an image feature may include operations S210 to S230.

In operation S210, an original image is divided into a plurality of local images as an image to be processed, and each local image of the plurality of local images includes a plurality of image blocks.

In the embodiment of the present disclosure, there may be no overlapping between the local images.

For example, the original image is a 4*4 image, and the local image may be a 2*2 image. There are four local images for the original image.

For example, the original image is a 4*3 image. After forming a 4*4 image by performing an edge filling (such as filling a fixed value) on one side of the original image, the 4*4 image may be divided to obtain four 2*2 local images.

In the embodiment of the present disclosure, there may be overlapping between the local images.

For example, the original image is a 4*3 image. The original image may be divided directly to obtain four 2*2 local images. Among these local images, two local images include two identical image blocks, and the other two local images include another two identical image blocks.

In the embodiment of the present disclosure, the above-mentioned plurality of image blocks are N*N image blocks, and N is an integer greater than or equal to 2.

For example, the local image may include 2*2 image blocks. For another example, the local image may include 3*3 image blocks.

In operation S220, a local feature of the image to be processed is determined according to a relationship between each image block in each local image.

In the embodiment of the present disclosure, a local feature of each local image is determined according to the relationship between each image block in each local image, thereby determining the local feature of the image to be processed.

For example, the CNN may be used to perform convolution on each local image to obtain the local feature of each local image. The local feature of each local image may be fused to obtain the local feature of the image to be processed. In one example, the local image is a 2*2 image, a 2*2 convolution kernel or a 1*1 convolution kernel may be used for convolution, and a convolution result may be used as the local feature of the image to be processed.

For another example, an attention model may be used to process each local image, so as to obtain the local feature of each local image. The local feature of each local image may be fused to obtain the local feature of the image to be processed.

In operation S230, a global feature of the image to be processed is determined according to a relationship between a first image block at a preset position in a local image of the plurality of local images and one or more second image blocks at the preset position in other local images of the plurality of local images.

In the embodiment of the present disclosure, the preset position may be different for each local image.

For example, the original image is a 4*4 image, the local image may be a 2*2 image, and there are four local images. The preset position may be an upper left corner for a first local image, an upper right corner for a second local image, a lower left corner for a third local image, and a lower right corner for a fourth local image.

In the embodiment of the present disclosure, the preset position may be the same position on each local image.

For example, the original image is a 4*4 image, the local image may be a 2*2 image, and there are four local images. The preset position may be an upper left corner for each of the four local images.

In the embodiment of the present disclosure, there are one or more preset positions.

For example, the original image is a 4*4 image, the local image may be a 2*2 image, and there are four local images. The preset position includes a first preset position and a second preset position. The first preset position may be the upper left corner for each of the four local images. The second preset positions may be the lower left corner for each of the four local images.

For example, the original image is a 4*4 image, the local image may be a 2*2 image, and there are four local images. The preset position includes a first preset position, a second preset position, a third preset position, and a fourth preset position. The first preset position may be the upper left corner for each of the four local images. The second preset position may be the lower left corner for each of the four local images. The third preset position may be the upper right corner for each of the four local images. The fourth preset position may be the lower right corner for each of the four local images.

For example, the original image is a 4*4 image, the local image may be a 2*2 image, and there are four local images. The preset position may be the upper left corner for each of the four local images, and then one first image block and three second image blocks may be obtained. The four image blocks may be compared, and the global feature may be determined according to differences or similarities of the four image blocks.

It should be understood that, in the embodiment of the present disclosure, the operation S220 may be executed before the operation S230; or the operation S230 may be executed before the operation S220; or the operation S220 may be executed in parallel with the operation S230.

Through the embodiment of the present disclosure, the image is divided into a plurality of local images; the local feature is calculated for each local image; and the global feature is calculated according to a relationship between image blocks at the same position in each local image, so that the calculation of the local feature may be combined with the calculation of the global feature, which has a strong expression ability and a high operation efficiency.

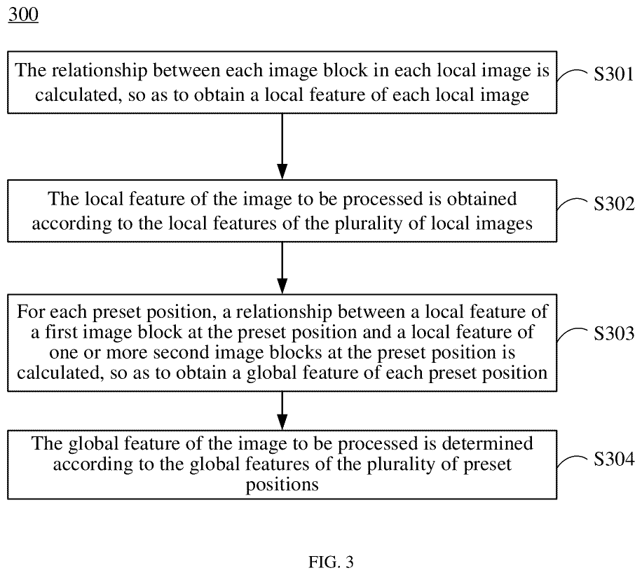

FIG. 3 is a flowchart of a method of determining an image feature according to another embodiment of the present disclosure.

As shown in FIG. 3, a method 300 of determining an image feature may include dividing an original image into a plurality of local images as an image to be processed, and each local image of the plurality of local images includes a plurality of image blocks.

The method of determining an image feature may further determine a local feature of the image to be processed according to a relationship between each image block in each local image. The following operations S301 to S302 will be referred to for detailed description.

In operation S301, the relationship between each image block in each local image is calculated, so as to obtain a local feature of each local image.

For example, the local image is a 2*2 image, and there are four image blocks. The local feature of the local image may be obtained according to a relationship (such as a similarity between image blocks) between image blocks.

In operation S302, the local feature of the image to be processed is obtained according to the local features of the plurality of local images.

For example, the original image is a 4*4 image. There are four local images, all of which are 2*2 images. The local features of the four local images obtained may be fused to obtain the local feature of the image to be processed. In one example, the local features of the four local images may be spliced. When splicing the local features of the four local images, a position of a local feature on the local feature of the image to be processed corresponds to a position of the local image, from which the local feature is obtained, on the image to be processed.

Next, the method 300 of determining an image feature may determine a global feature of the image to be processed according to a relationship between a first image block at a preset position in a local image of the plurality of local images and one or more second image blocks at the preset position in other local images of the plurality of local images. The following operations S303 to S304 will be referred to for detailed description. The local image includes a plurality of preset positions, and each preset position of the plurality of preset positions corresponds to one image block.

In operation S303, for each preset position, a relationship between a local feature of a first image block at the preset position and a local feature of one or more second image blocks at the preset position is calculated, so as to obtain a global feature of each preset position.

For example, the original image is a 4*4 image, the local image may be a 2*2 image, and there are four local images. The preset position includes the first preset position, the second preset position, the third preset position, and the fourth preset position. The first preset position may be the upper left corner for each of the four local images. The second preset position may be the lower left corner for each of the four local images. The third preset position may be the upper right corner for each of the four local images. The fourth preset position may be the lower right corner for each of the four local images.

A global feature of the first preset position may be determined according to a relationship between a local feature of the first image block located at the first preset position on a local image and a local feature of one or more second image blocks located at the first preset position on other local images (such as a similarity between local features of four image blocks located at the first preset position). Global features of the second preset position to the fourth preset position may be determined in the same or similar manner.

In operation S304, the global feature of the image to be processed is determined according to the global features of the plurality of preset positions.

For example, the original image is a 4*4 image, the local image may be a 2*2 image, and there are four local images. The preset position includes the first preset position, the second preset position, the third preset position, and the fourth preset position. The global feature of the image to be processed may be determined according to the global feature of the first preset position to the global feature of the fourth preset position. In one example, the global feature is a color feature, and a color feature of the image to be processed may be obtained according to color features of the four preset positions. For example, a color histogram may be used to represent the color feature. Color histograms of the four preset positions may be integrated to obtain one color feature representing the image to be processed.

FIG. 4 is a flowchart of a method of determining an image feature according to another embodiment of the present disclosure.

A method 400 of determining an image feature may include dividing an original image into a plurality of local images as an image to be processed, and each local image of the plurality of local images includes a plurality of image blocks.

Next, the method 400 of determining an image feature may determine a global feature of the image to be processed according to a relationship between a first image block at a preset position in a local image of the plurality of local images and one or more second image blocks at the preset position in other local images of the plurality of local images. The following operations S401 to S402 will be referred to for detailed description. The local image includes a plurality of preset positions, and each preset position of the plurality of preset positions corresponds to one image block.

In operation S401, for each preset position, a relationship between a first image block at the preset position and one or more second image blocks at the preset position is calculated, so as to obtain a global feature of each preset position.

For example, the original image is a 4*4 image, the local image may be a 2*2 image, and there are four local images. The preset position includes the first preset position, the second preset position, the third preset position, and the fourth preset position. The first preset position may be the upper left corner for each of the four local images. The second preset position may be the lower left corner for each of the four local images. The third preset position may be the upper right corner for each of the four local images. The fourth preset position may be the lower right corner for each of the four local images.

The global feature of the first preset position may be determined according to a relationship between the first image block located at the first preset position on a local image and one or more second image blocks located at the first preset position on other local images (such as a similarity between four image blocks located at the first preset position). Global features of the second preset position to the fourth preset position may be determined in the same or similar manner.

In operation S402, the global feature of the image to be processed is determined according to the global features of the plurality of preset positions.

For example, the original image is a 4*4 image, the local image may be a 2*2 image, and there are four local images. The preset position includes the first preset position, the second preset position, the third preset position, and the fourth preset position. The global feature of the image to be processed may be determined according to the global feature of the first preset position to the global feature of the fourth preset position. In one example, the global feature is the color feature, and the color feature of the image to be processed may be obtained according to color features of the four preset positions. For example, the color histogram may be used to represent the color feature. Color histograms of the four preset positions may be integrated to obtain one color feature representing the image to be processed.

Next, the method 400 of determining an image feature may further determine a local feature of the image to be processed according to a relationship between each image block in each local image. The following operations S403 to S404 will be referred to for detailed description.

In operation S403, a relationship between a global feature of each image block in each local image is calculated, so as to obtain a local feature of each local image, and the global feature of each image block is a global feature of a preset position corresponding to each image block.

For example, the local image is a 2*2 image. There are four image blocks, each of which corresponds to a preset position. The local feature of the local image may be obtained according to the relationship between global features of image blocks (such as the similarity between global features of image blocks).

In operation S404, the local feature of the image to be processed is obtained according to the local features of the plurality of local images.

For example, the original image is a 4*4 image. There are four local images, all of which are 2*2 images. The local features of the four local images obtained may be fused to obtain the local feature of the image to be processed. In one example, the local features of the four local images may be spliced.

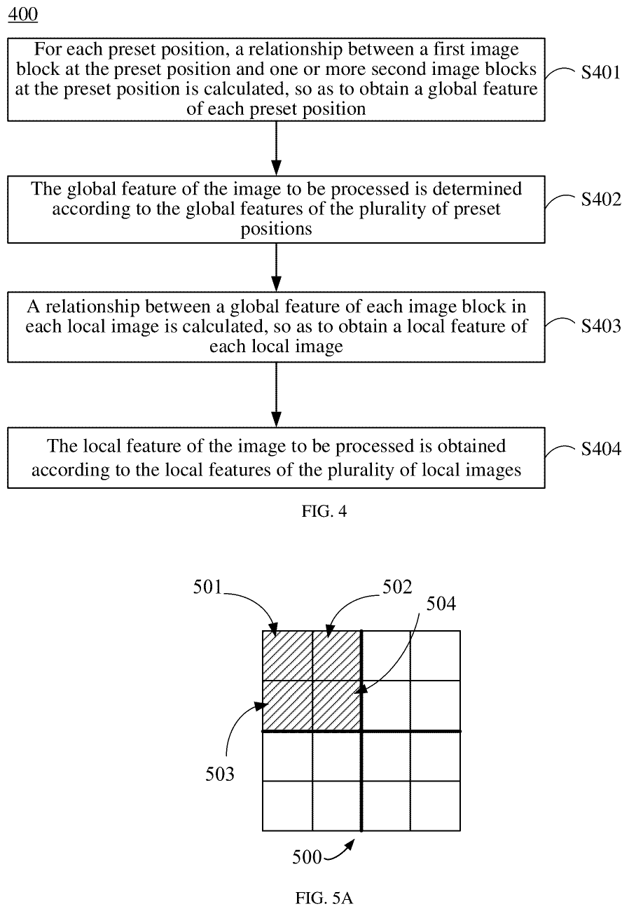

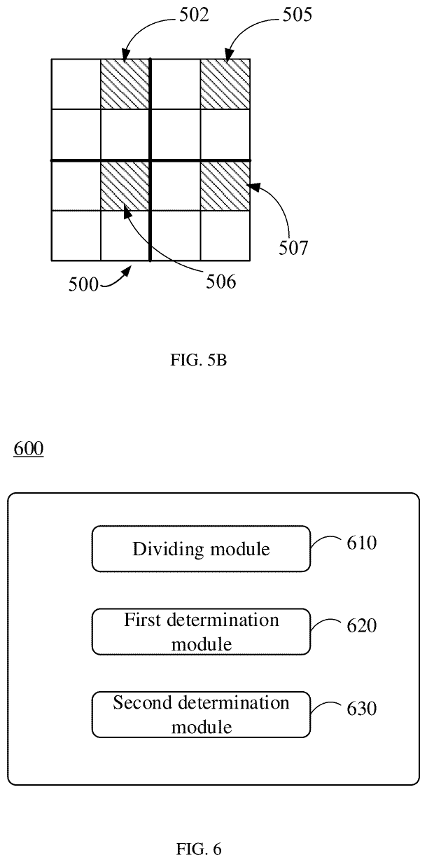

FIG. 5A is a schematic diagram of calculating a local feature according to an embodiment of the present disclosure.

As shown in FIG. 5A, after an original image is divided into four local images, the original image is taken as an image 500 to be processed. A local image located at the upper left of the image 500 to be processed includes four image blocks, namely, an image block 501, an image block 502, an image block 503, and an image block 504.

The local feature of the local image may be determined according to a relationship between the image blocks 501, 502, 503, and 504. Local features of the other three local images may be determined in the same or similar way, and then a local feature of the image 500 to be processed may be determined.

FIG. 5B is a schematic diagram of calculating a global feature according to an embodiment of the present disclosure.

As shown in FIG. 5B, after the original image 500 is divided into four local images, the original image 500 is taken as the image 500 to be processed. Each local image includes four image blocks.

For each local image, the preset position may be the upper right corner (for example, the second preset position described above) of the local image. The global feature for the above-mentioned preset position may be determined according to a relationship between four image blocks (such as an image block 502, an image block 505, an image block 506 and an image block 507 in FIG. 5B) located at the preset position in the four local images. Similarly, global features for other preset positions may be obtained. A global feature of the image 500 to be processed may be obtained based on a combination of global features for all preset positions.

It should be noted that the calculation of the local feature and the calculation of the global feature may be combined. For example, a functional module may be generated to achieve the calculation of the local feature and the calculation of the global feature. The functional module may be operated to perform the calculation of the local feature first and then the calculation of the global feature, or perform the calculation of the global feature first and then the calculation of the local feature.

The above-mentioned functional module may be used as a processing layer of a neural network to replace some layers in the existing neural network, so that the existing neural network may give consideration to both expression ability and operation efficiency.

For example, the CNN model includes a plurality of convolution layers. The above-mentioned functional module may be used as a processing layer of the CNN model to replace an original preset layer (for example, the last three convolution layers) in the CNN model, so that the CNN model may improve the expression ability.

For another example, the Transformer model includes a plurality of global feature computing layers. The above-mentioned functional module may be used as a processing layer of the Transformer model to replace an original preset layer (for example, the first three global feature computing layers) in the Transformer model, so that the Transformer model may improve the operation efficiency.

FIG. 6 is a block diagram of an apparatus of determining an image feature according to an embodiment of the present disclosure.

As shown in FIG. 6, a method 600 of determining an image feature may include a dividing module 610, a first determination module 620, and a second determination module 630.

The dividing module 610 is used to divide an original image into a plurality of local images as an image to be processed, and each local image of the plurality of local images includes a plurality of image blocks.

The first determination module 620 is used to determine a local feature of the image to be processed according to a relationship between each image block in each local image.

The second determination module 630 us used to determine a global feature of the image to be processed according to a relationship between a first image block at a preset position in a local image of the plurality of local images and one or more second image blocks at the preset position in other local images of the plurality of local images.

In some embodiments, the first determination module includes a first calculation unit used to calculate the relationship between each image block in each local image, so as to obtain a local feature of each local image; and a first determination unit used to obtain the local feature of the image to be processed according to the local features of the plurality of local images.

In some embodiments, the local image includes a plurality of preset positions, each preset position of the plurality of preset positions corresponds to one image block, and the second determination module includes a second calculation unit used to, for each preset position, calculate a relationship between a local feature of a first image block at the preset position and a local feature of one or more second image blocks at the preset position, so as to obtain a global feature of each preset position; and a second determination unit used to determine the global feature of the image to be processed according to the global features of the plurality of preset positions.

In some embodiments, the local image includes a plurality of preset positions, each preset position of the plurality of preset positions corresponds to one image block, and the second determination module includes a third calculation unit used to, for each preset position, calculating a relationship between a first image block at the preset position and one or more second image blocks at the preset position, so as to obtain a global feature of each preset position; and a third determination unit used to determine the global feature of the image to be processed according to the global features of the plurality of preset positions.

In some embodiments, the first determination module includes a fourth calculation unit used to calculate a relationship between a global feature of each image block in each local image, so as to obtain a local feature of each local image, and the global feature of each image block is a global feature of a preset position corresponding to the each image block; and a fourth determination unit used to obtain the local feature of the image to be processed according to the local features of the plurality of local images.

In some embodiments, the plurality of image blocks are N*N image blocks, and N is an integer greater than or equal to 2.

According to an embodiment of the present disclosure, the present disclosure further provides an electronic device, a readable storage medium, and a computer program product.

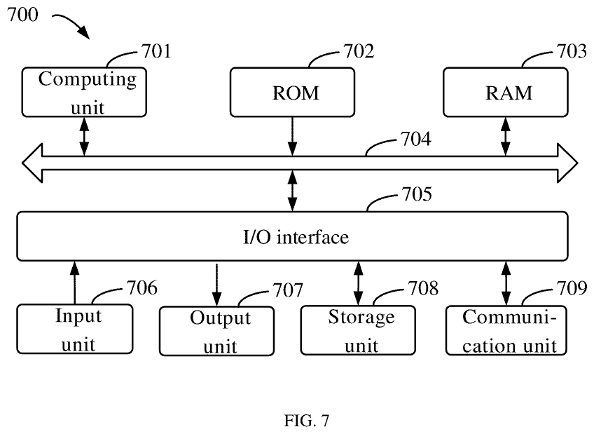

FIG. 7 shows a schematic block diagram of an exemplary electronic device 700 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the device 700 may include a computing unit 701, which may perform various appropriate actions and processing based on a computer program stored in a read-only memory (ROM) 702 or a computer program loaded from a storage unit 708 into a random access memory (RAM) 703. Various programs and data required for the operation of the device 700 may be stored in the RAM 703. The computing unit 701, the ROM 702 and the RAM 703 are connected to each other through a bus 704. An input/output (I/O) interface 705 is further connected to the bus 704.

Various components in the device 700, including an input unit 706 such as a keyboard, a mouse, etc., an output unit 707 such as various types of displays, speakers, etc., a storage unit 708 such as a magnetic disk, an optical disk, etc., and a communication unit 709 such as a network card, a modem, a wireless communication transceiver, etc., are connected to the I/O interface 705. The communication unit 709 allows the device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 701 may perform the various methods and processes described above, such as the method of determining an image feature. For example, in some embodiments, the method of determining an image feature may be implemented as a computer software program that is tangibly contained on a machine-readable medium, such as a storage unit 708. In some embodiments, part or all of a computer program may be loaded and/or installed on the device 700 via the ROM 702 and/or the communication unit 709. When the computer program is loaded into the RAM 703 and executed by the computing unit 701, one or more steps of the method of determining an image feature described above may be performed. Alternatively, in other embodiments, the computing unit 701 may be configured to perform the method of determining an image feature in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine-readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of determining an image feature, the method comprising:
dividing an original image into a plurality of local images as an image to be processed, wherein each local image of the plurality of local images comprises a plurality of image blocks;
determining a local feature of the image to be processed according to a relationship between each image block in each local image; and
determining a global feature of the image to be processed according to a relationship between a first image block at a preset position in a local image of the plurality of local images and one or more second image blocks at the preset position in other local images of the plurality of local images.

2. The method according to claim 1, wherein the determining a local feature of the image to be processed according to a relationship between each image block in each local image comprises:
calculating the relationship between each image block in each local image, so as to obtain a local feature of each local image; and
obtaining the local feature of the image to be processed according to the local features of the plurality of local images.

3. The method according to claim 2, wherein the local image comprises a plurality of preset positions, each preset position of the plurality of preset positions corresponds to one image block, and
wherein the determining a global feature of the image to be processed according to a relationship between a first image block at a preset position in a local image of the plurality of local images and one or more second image blocks at the preset position in other local images of the plurality of local images comprises:
for each preset position, calculating a relationship between a local feature of a first image block at the preset position and a local feature of one or more second image blocks at the preset position, so as to obtain a global feature of each preset position; and
determining the global feature of the image to be processed according to the global features of the plurality of preset positions.

4. The method according to claim 1, wherein the local image comprises a plurality of preset positions, each preset position of the plurality of preset positions corresponds to one image block, and
wherein the determining a global feature of the image to be processed according to a relationship between a first image block at a preset position in a local image of the plurality of local images and one or more second image blocks at the preset position in other local images of the plurality of local images comprises:
for each preset position, calculating a relationship between a first image block at the preset position and one or more second image blocks at the preset position, so as to obtain a global feature of each preset position; and
determining the global feature of the image to be processed according to the global features of the plurality of preset positions.

5. The method according to claim 4, wherein the determining a local feature of the image to be processed according to a relationship between each image block in each local image comprises:
calculating a relationship between a global feature of each image block in each local image, so as to obtain a local feature of each local image, wherein the global feature of each image block is a global feature of a preset position corresponding to the each image block; and
obtaining the local feature of the image to be processed according to the local features of the plurality of local images.

6. The method according to claim 1, wherein the plurality of image blocks are N*N image blocks, and N is an integer greater than or equal to 2.

7.-12. (canceled)

13. An electronic device, comprising:
at least one processor; and
a memory communicatively connected to the at least one processor, wherein the memory stores instructions executable by the at least one processor, and the instructions, when executed by the at least one processor, cause the at least one processor to at least:
divide an original image into a plurality of local images as an image to be processed, wherein each local image of the plurality of local images comprises a plurality of image blocks;
determine a local feature of the image to be processed according to a relationship between each image block in each local image; and
determine a global feature of the image to be processed according to a relationship between a first image block at a preset position in a local image of the plurality of local images and one or more second image blocks at the preset position in other local images of the plurality of local images.

14. A non-transitory computer-readable storage medium having computer instructions stored thereon or therein, wherein the computer instructions are configured to cause a computer system to at least:
divide an original image into a plurality of local images as an image to be processed, wherein each local image of the plurality of local images comprises a plurality of image blocks;
determine a local feature of the image to be processed according to a relationship between each image block in each local image; and
determine a global feature of the image to be processed according to a relationship between a first image block at a preset position in a local image of the plurality of local images and one or more second image blocks at the preset position in other local images of the plurality of local images.

15. (canceled)

16. The method according to claim 2, wherein the plurality of image blocks are N*N image blocks, and N is an integer greater than or equal to 2.

17. The electronic device according to claim 13, wherein the instructions, when executed by the at least one processor, are further configured to cause the at least one processor to:
calculate the relationship between each image block in each local image, so as to obtain a local feature of each local image; and
obtain the local feature of the image to be processed according to the local features of the plurality of local images.

18. The electronic device according to claim 17, wherein the local image comprises a plurality of preset positions, each preset position of the plurality of preset positions corresponds to one image block, and
wherein the instructions, when executed by the at least one processor, are further configured to cause the at least one processor to:
for each preset position, calculate a relationship between a local feature of a first image block at the preset position and a local feature of one or more second image blocks at the preset position, so as to obtain a global feature of each preset position; and determine the global feature of the image to be processed according to the global features of the plurality of preset positions.

19. The electronic device according to claim 13, wherein the local image comprises a plurality of preset positions, each preset position of the plurality of preset positions corresponds to one image block, and
wherein the instructions, when executed by the at least one processor, are further configured to cause the at least one processor to:
for each preset position, calculate a relationship between a first image block at the preset position and one or more second image blocks at the preset position, so as to obtain a global feature of each preset position; and
determine the global feature of the image to be processed according to the global features of the plurality of preset positions.

20. The electronic device according to claim 19, wherein the instructions, when executed by the at least one processor, are further configured to cause the at least one processor to:
calculate a relationship between a global feature of each image block in each local image, so as to obtain a local feature of each local image, wherein the global feature of each image block is a global feature of a preset position corresponding to the each image block; and
obtain the local feature of the image to be processed according to the local features of the plurality of local images.

21. The electronic device according to claim 13, wherein the plurality of image blocks are N*N image blocks, and N is an integer greater than or equal to 2.

22. The electronic device according to claim 17, wherein the plurality of image blocks are N*N image blocks, and N is an integer greater than or equal to 2.

23. The non-transitory computer-readable storage medium according to claim 14, wherein the computer instructions are further configured to cause the computer system to:
calculate the relationship between each image block in each local image, so as to obtain a local feature of each local image; and
obtain the local feature of the image to be processed according to the local features of the plurality of local images.

24. The non-transitory computer-readable storage medium according to claim 23, wherein the local image comprises a plurality of preset positions, each preset position of the plurality of preset positions corresponds to one image block, and
wherein the computer instructions are further configured to cause the computer system to:
for each preset position, calculate a relationship between a local feature of a first image block at the preset position and a local feature of one or more second image blocks at the preset position, so as to obtain a global feature of each preset position; and
determine the global feature of the image to be processed according to the global features of the plurality of preset positions.

25. The non-transitory computer-readable storage medium according to claim 14, wherein the local image comprises a plurality of preset positions, each preset position of the plurality of preset positions corresponds to one image block, and
wherein the computer instructions are further configured to cause the computer system to:
for each preset position, calculate a relationship between a first image block at the preset position and one or more second image blocks at the preset position, so as to obtain a global feature of each preset position; and
determine the global feature of the image to be processed according to the global features of the plurality of preset positions.

26. The non-transitory computer-readable storage medium according to claim 25, wherein the computer instructions are further configured to cause the computer system to:
calculate a relationship between a global feature of each image block in each local image, so as to obtain a local feature of each local image, wherein the global feature of each image block is a global feature of a preset position corresponding to the each image block; and
obtain the local feature of the image to be processed according to the local features of the plurality of local images.

27. The non-transitory computer-readable storage medium according to claim 14, wherein the plurality of image blocks are N*N image blocks, and N is an integer greater than or equal to 2.
